(19) United States
(12) Patent Application Publication
(10) Pub. No.: US 2018/0047219 A1
(43) Pub. Date: Feb. 15, 2018

(54) TELEMATICS CONTROL SYSTEM TRACKING AND MONITORING

(71) Applicant: Jaguar Land Rover Limited, Whitley (GB)

(72) Inventors: Deborah BUSWELL, Coventry, Warwickshire (GB); Tony LOWE, Coventry, Warwickshire (GB); Mark BURNET, Coventry, Warwickshire (GB)

(21) Appl. No.: 15/554,401

(22) PCT Filed: Mar. 7, 2016
(86) PCT No.: PCT/EP2016/054752

§ 371 Date: Aug. 29, 2017

(30) Foreign Application Priority Data
Mar. 9, 2015 (GB) 1503986.0

(51) Int. Cl. G07C 5/00; G07C 5/08; G06Q 10/08

(52) U.S. Cl. CPC G07C 5/008; G06Q 10/08; G07C 5/08; B60W 2550/40

(57) ABSTRACT

The present invention provides a telematics control system for use in a vehicle for determining whether to transmit vehicle data to off-board the vehicle, the vehicle including a vehicle battery and one or more vehicle sensors. The system includes an input arranged to receive vehicle data from at least one of the one or more on-board vehicle sensors, a processor arranged to determine whether the vehicle battery is operably connected to the system, and an output arranged to transmit a wireless communications message indicative of the received vehicle data to off-board the vehicle. The system further includes a logistics activated mode in which it is operable to transmit communications messages and a logistics quiet mode in which it draws no power from the vehicle battery. The processor is operable to switch from the logistics quiet mode to the logistics activated mode when it determines that the vehicle battery is operably connected to the system, and in the logistics activated mode to send the communications message from the output, so as to transmit vehicle data to off-board the vehicle.

### TECHNICAL FIELD

The present disclosure relates to a telematics control system for use in a vehicle and particularly, but not exclusively to a system that is operable in a logistics mode to transmit vehicle data to off-board the vehicle. Aspects of the invention relate to a system, to a method, and to a vehicle.

### BACKGROUND

The logistics of transporting finished vehicles from a manufacturing production line to a dealership where the vehicle will be sold gives rise to many problems. This is a particular issue when transporting vehicles on a global scale, including to different regions and markets. These problems may arise from inter alia a lack of timely and accurate recordation of information into a system database. Current systems rely on manual input which can be inefficient and unreliable. The information that is to be input may include a vehicle's current geographical location during transportation to a dealership, or details of pre-sale maintenance checks.

Examples of such problems that the above systems cause are as follows. Firstly, a problem that arises during transportation is the inability to determine accurately how much fuel is in a vehicle at a given point in time. This is important from, amongst other things, a tax perspective, when transporting vehicles globally. In addition, vehicle status issues may arise during transportation, such as batteries becoming flat and needing replacement or tyre pressures being too low. At present, this may go undetected and unreported, resulting in delays in providing a fully-functioning vehicle to the end user.

Also, if information relating to the geographical location of the vehicles is not entered into a system then this leads to inaccuracies in, and the inability to manage, the global inventory. This can lead to poor decisions being made regarding, for example, the volume of vehicles that need to be transported to a certain region. Current vehicles may have externally-fitted tracking devices (e.g. RFID tags); however, they are lost easily and are subject to both initial costs (e.g. tracking infrastructure) and ongoing costs (e.g. annual service charge).

Next, the present systems may lead to cash flow problems. This is because the points of revenue recognition (i.e. when revenues are realised) are different in different markets and for different brands. Since processes may be manual, non-standard, slow, complex and/or difficult to monitor, this can lead to delayed revenue realisation and hence can have a significant cost impact.

Current systems may also lead to a lack of compliance; for example, delays in notification by a dealer that a vehicle has arrived at a dealership, or that a vehicle has passed a particular check point (e.g. a port) during transportation. Different organisations may place varying degrees of importance on certain protocols which leads to these delays in notification of vehicle arrival or movement.

An aim of the present invention is to provide a system that addresses the problems associated with the prior art that are outlined above, whilst solving the technical challenges of implementing such a system in a way that does not adversely impact the charge of the vehicle battery even for journeys that could be months in duration.

### SUMMARY OF THE INVENTION

Aspects and embodiments of the invention provide a system, a method and a vehicle as claimed in the appended claims.

According to an aspect of the invention, there is provided a telematics control system, or other system comprising the features outlined herein, for use in a vehicle for determining whether to transmit vehicle data to off-board the vehicle. The vehicle may include a vehicle battery and one or more vehicle sensors. The system may include an input arranged to receive vehicle data from at least one of the one or more on-board vehicle sensors, a processor arranged to determine whether the vehicle battery is operably connected to the system, and an output arranged to transmit a wireless communications message indicative of the received vehicle data to off-board the vehicle. The system may also include a logistics activated mode in which it is operable to transmit communications messages and a logistics quiet mode in which it draws no power from the vehicle battery. In addition, the processor may be operable to switch from the logistics quiet mode to the logistics activated mode when it determines that the vehicle battery is operably connected to the system. Furthermore, in the logistics activated mode the processor may be operable to send the communications message from the output, so as to transmit vehicle data to off-board the vehicle.

The system of the presently claimed invention advantageously is operable throughout a logistics stage of the vehicle. In particular, the system advantageously includes a logistics mode, and is operable in the logistics mode during the logistics stage to provide the functionality of the present invention. The system remains operable during the logistics stage by utilising the occasions during this stage in which the vehicle ignition or vehicle engine is switched on to avoid draining the vehicle battery. The vehicle battery may automatically operably connect to the system in the event that the vehicle ignition or vehicle engine is switched on. In these cases the system is operable to transmit messages indicative of vehicle data to off-board the vehicle without draining the vehicle battery power. This allows the current state of different vehicle-related features to be monitored and perhaps acted upon throughout the logistics stage.

Note that it is not the case that the system is operable in the logistics activated mode only when the vehicle ignition or vehicle engine is switched on, rather that the system is simply operable to switch from the logistics quiet mode to the logistics activated mode in such a case.

Note that when the engine of the vehicle is running this is charging the vehicle battery and also a rechargeable battery associated with the telematics control system that enables the telematics control system to complete its task of sending data off-vehicle even in the case where the vehicle is turned off and the vehicle battery disconnected prior to the telematics control system completing said task.

The input, processor and output may comprise an electronic control unit or one or more controllers. The electronic controller, or the one or more controllers may have, associated therewith, micro-processors programmed to execute the required functions. For example, the system may comprise a memory device in communication with the processor and having instructions stored therein. The processor may be arranged to access the memory device and execute the instructions stored therein such that it is operable to determine whether the vehicle battery is operably connected to the system. In this case the processor is also arranged to switch from the logistics quiet mode to the logistics activated mode when it determines that the vehicle battery is operably connected to the system, and in the logistics activated mode the processor is also operable to send the communications message from the output, so as to transmit vehicle data to off-board the vehicle.

When in the logistics activated mode, the system may be operable to activate at least one of the vehicle sensors. This ensures that vehicle data is collected when the vehicle engine is switched on, but that they do not drain the battery when the engine is switched off.

In some embodiments, the vehicle data includes location data relating to a current location of the vehicle, the one or more vehicle sensors including a location data antenna for receiving the location data, and the input including a position data input arranged to receive the location data from the location data antenna. This is advantageous to allow geographical location of the vehicle to be tracked, particularly during a logistics stage of the vehicle's life-cycle when the vehicle engine is normally switched off. The location data antenna may include a GPS or other positioning system antenna, and the position data input may include a GPS or other positioning data receiver.

In some embodiments the vehicle data includes quality data relating to one or more vehicle features, the one or more vehicle sensors including one or more quality data sensors for measuring the quality data, and the input including a quality data input arranged to receive the quality data from the quality data sensors. This advantageously allows the status of various vehicle functions to be monitored and for problems to be highlighted, particularly during a logistics stage of the vehicle's life-cycle, when such information is not normally available.

The vehicle may include one or more electronic control units, with the quality data input being arranged to receive the quality data from the quality data sensors via the electronic control units. In addition, the electronic control units may process the quality data received from the quality data sensors before the quality data is received by the quality data input. This advantageously allows conclusions relating to the received quality data to be sent to the telematics control system. For example, the electronic control units may send Diagnostic Trouble Codes if there is a problem detected with one or more of the vehicle functions.

The vehicle may include a controller area network or other vehicle network infrastructure, wherein the system communicates with the electronic control units via the controller area network or other vehicle network infrastructure. The quality data may include at least one of data indicative of at least one of the vehicle battery voltage level or state of charge, the amount of fuel in the vehicle, the odometer value, the oil level, the brake fluid level, and a tyre pressure of one or more tyres of the vehicle. It will be appreciated that this list is non-exhaustive.

In some embodiments the vehicle includes a wireless transmitting antenna, and the output includes a wireless transmitter arranged to transmit the communications message to off-board the vehicle via the wireless transmitting antenna. This advantageously allows vehicle data to be monitored and/or further processed off-board the vehicle, to be used to rectify problems or report the progress of the vehicle.

The vehicle may include a vehicle engine, where the processor determines that the vehicle battery is operably connected to the system when the vehicle engine or ignition is switched on.

In some embodiments the vehicle includes a wireless receiving antenna arranged to receive a communications message from off-board the vehicle with instructions to be carried out by the processor. In such embodiments the input includes a wireless receiver arranged to receive the communications message from the wireless receiving antenna, and the processor is arranged to process the instructions received by the wireless receiver. This allows the vehicle to receive instructions from off-board the vehicle with strategies to, for example, rectify problems highlighted in the received vehicle data. The output may include a quality data output arranged to send the processed instructions to one or more of the electronic control units, so that they may carry out the instructions. The processed instructions may include instructions for at least one of the electronic control units to perform at least one of a diagnostics check, a software update, a tyre pressure adjustment, a vehicle engine performance assessment, and an instruction to place the vehicle engine into a safe mode. This could help to save time at the end of the logistics stage by solving problems associated with the vehicle before it is delivered to, for example, a dealership or an end user.

The processor may be operable to assess the performance of the vehicle engine and/or to perform a diagnostics check. The processor may be operable to send control signals to rectify a detected problem with the vehicle engine. This would allow the vehicle to rectify problems identified in the received vehicle data without sending the data off-board the vehicle.

In some embodiments the system includes a system battery, wherein the system battery is arranged to power the system when the vehicle battery is not operably connected to the system. This advantageously allows the system to remain operable to receive and/or transmit vehicle data when the vehicle battery is not operably connected to the system (including when the vehicle engine is switched off). The system may be arranged to draw no power from the system battery when the vehicle battery is operably connected to the system and/or to recharge when the vehicle battery is operably connected to the system. This advantageously makes optimum use of the power available to the system at any given time.

When the system is operating in the logistics quiet mode, it may check periodically whether any wireless messages have been received. These periodic checks may occur at predetermined intervals of time. Again, this ensures that battery power is not wasted. When it is determined that wireless messages have been received, the processor may be operable to switch from the logistics quiet mode to the logistics activated mode. The system may be arranged to draw power from the vehicle battery and/or the system battery such that the power consumption is below a predetermined level. In this regard, the system may be arranged to remain operable while utilising the vehicle battery and/or system battery in order to substantially minimise the power consumption.

In some embodiments the system is arranged to operate in the logistics activated mode for a predetermined period after it is determined that the vehicle battery is not operably connected to the system. In embodiments, the system is arranged to operate in the logistics activated mode after it is determined that the vehicle battery is not operably connected to the system, for a period sufficient to ensure establishment of a communications connection. This may be so that the vehicle can continue to try to send and/or receive messages in an area with poor network coverage, and may also or alternatively be until the battery power reaches a predetermined level.

According to another aspect of the present invention, there is provided a telematics control method for use in a vehicle for determining whether to transmit vehicle data to off-board the vehicle, the vehicle including a vehicle battery, one or more vehicle sensors and a telematics control system. The method includes receiving vehicle data from at least one of the one or more on-board vehicle sensors, determining whether the vehicle battery is operably connected to the system, and transmitting a wireless communications message indicative of the received vehicle data to off-board the vehicle. The system includes a logistics activated mode in which it is operable to transmit communications messages and a logistics quiet mode in which it draws no power from the vehicle battery, and the method includes switching the system from the logistics quiet mode to the logistics activated mode when it is determined that the vehicle battery is operably connected to the system, and in the logistics activated mode to send the communications message, so as to transmit vehicle data to off-board the vehicle.

According to still another aspect of the invention, there is provided a telematics control method for use with a vehicle, the vehicle including a vehicle battery, one or more vehicle sensors and a telematics control system, the method comprising: receiving vehicle data from at least one of the on-board vehicle sensors; determining whether the vehicle battery is operably connected to the system; and transmitting a wireless communications message indicative of the received vehicle data to off-board the vehicle; wherein the system includes a logistics activated mode in which it is operable to transmit communications messages and a logistics quiet mode in which it draws no power from the vehicle battery, wherein the method includes: switching the system from the logistics quiet mode to the logistics activated mode when it is determined that the vehicle battery is operably connected to the system, and in the logistics activated mode to send the communications message, so as to transmit vehicle data to off-board the vehicle; and transmitting the communications message to a logistics service provider.

According to a further aspect of the present invention, there is provided a non-transitory, computer-readable storage medium storing instructions thereon that when executed by one or more processors causes the one or more processors to carry out the method outlined herein.

According to a still further aspect of the present invention, there is provided a vehicle comprising a system as outlined herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying figures, in which:

FIG. 1 is a schematic overview of a vehicle provided with a telematics control unit (TCU) according to an embodiment of the present invention;

FIG. 2 is a schematic diagram of the TCU in FIG. 1;

FIG. 3 is a schematic diagram showing the inputs to and outputs from a logistics management system (LMS) according to an embodiment of the present invention.

### DETAILED DESCRIPTION

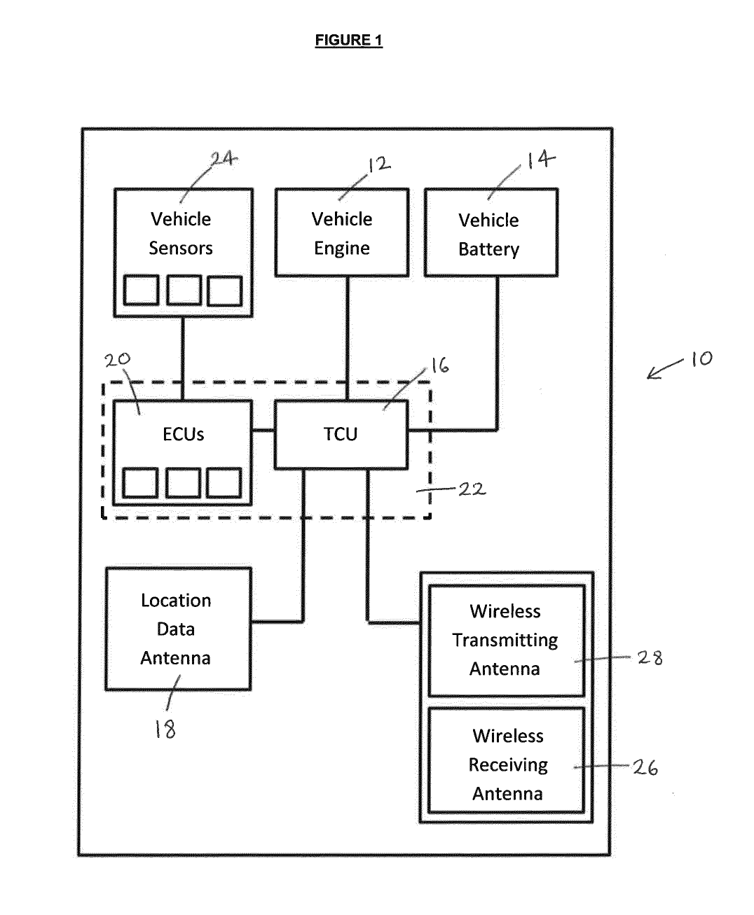

FIG. 1 shows one embodiment of a vehicle 10 with a vehicle engine 12 and a vehicle battery 14, the vehicle 10 also including a telematics control unit (TCU) or telematics control system 16 for carrying out a method according to an aspect of the present invention. In addition, the vehicle 10 includes a vehicle location data antenna or sensor 18 for receiving location data relating to the current location of the vehicle 10. For example, the location data antenna 18 may be a Global Positioning System (GPS) antenna for receiving signals from a GPS satellite, or could be compound, multiple or substitutable antennas for receiving from other positioning systems such as GLONASS, BeiDou or Galileo. The TCU 16 is in communication with one or more other electronic control units (ECUs) 20 via a controller area network (CAN) 22, or other vehicle network infrastructure such as TT Ethernet or Flexray. For example, the ECUs 20 may be for monitoring and/or controlling so-called vehicle features. These vehicle features may include the vehicle battery voltage or state of charge, the tyre pressure, the status of doors or windows, odometer, brake fluid level, oil level, break pad wear, and the fuel tank level. Data about said features could be in the form of either direct measurements, e.g. fuel remaining in litres, or alerts that are sent if a measurement falls outside a given threshold, e.g. battery state of charge <70%. Data may also be sent from other ECUs where logic in those ECUs have processed data and determined that there is some important condition such as a malfunction that could then be communicated off car in the form of a Diagnostic Trouble Code and potentially additional diagnostic information pertaining to the error. In particular, the ECUs 20 are connected to one or more so-called vehicle quality data sensors 24 arranged to measure data relating to these (and/or other) vehicle features. It will be understood that this list is non-limiting. The ECUs 20 communicate via the CAN, or other vehicle network infrastructure, 22 with the TCU 16 with sensor output data relating to the measured values of the one or more vehicle features. This sensor output data is referred to as vehicle quality data. The ECUs 20 may process the received quality data before sending it to the TCU 16. For example, the ECUs 20 may send information relating to the quality data, or conclusions about the quality data, such as Diagnostic Trouble Codes. This is also to be considered as quality data.

The vehicle 10 also includes a wireless communication receiving antenna 26 for receiving wireless signals from off-board the vehicle 10. In addition, the vehicle 10 may also include a wireless communication transmitting antenna 28 for sending wireless signals to off-board the vehicle 10. In practice, the wireless communication antennas 26, 28 may be a single unit wireless communication transceiver antenna 26, 28. The type of wireless communication may be any that are currently available, e.g. GSM, GPRS, Wi-Fi, WiMax or LTE, or any that are available in future such as the planned 5G.

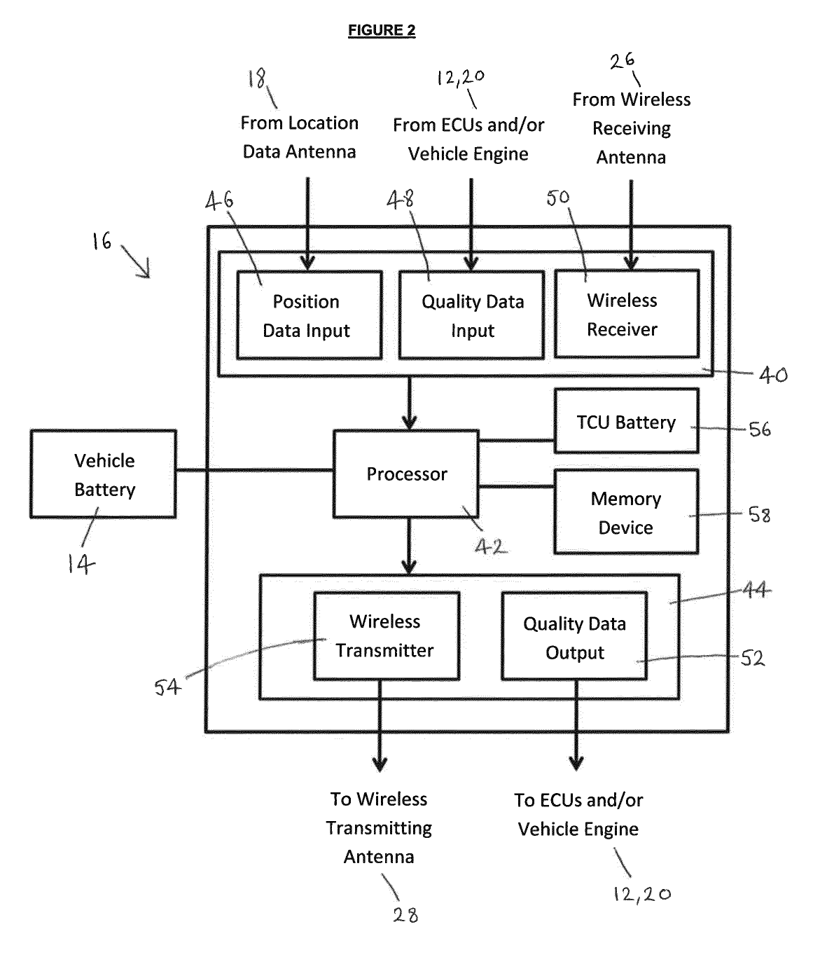

With reference to FIG. 2, the TCU 16 includes an input 40, a processor 42 and an output 44. The input 40 may include: a position data input 46 for receiving vehicle location data from the vehicle location data antenna 18, a quality data input 48 for receiving quality data from the ECUs 20 via the CAN or other vehicle network infrastructure 22, and a wireless TCU receiver (or system receiver) 50 for receiving wireless messages from the wireless receiving antenna 26. Note that the position data input 46 (e.g. a GPS receiver) is part of the TCU 16. The output 44 may include: a quality data output 52 for sending instructions from the processor 42 to the ECUs 20 via the vehicle network 22, and a wireless TCU transmitter (or system transmitter) 54 for transmitting wireless communications messages indicative of the received position and/or quality data to off-board the vehicle 10 via the wireless transmitting antenna 28. In practice, the TCU receiver 50 and the TCU transmitter 54 may be a single unit wireless TCU transceiver 50, 54.

The term “vehicle data” may be used to refer individually or collectively to the vehicle location data and the vehicle quality or diagnostic data. In addition, the vehicle data may include other types of data associated with the vehicle 10. Similarly, the position data input 46 and quality data input 48 may be referred to individually or collectively simply by “vehicle data inputs 46, 48”.

The TCU 16 is powered by the vehicle battery 14 when the vehicle battery 14 is operably connected to the TCU 16 (e.g. when the vehicle ignition or the vehicle engine 12 is switched on). Specifically the TCU 16 includes a logistics activated mode in which it is operable to transmit and/or receive communications messages, and a logistics quiet mode in which it draws no power from the vehicle battery 14. In the logistics activated mode, the TCU 16 is operable to activate one or more of the vehicle sensors 24.

The TCU 16 is operable in a logistics mode during at least part of a logistics stage of the vehicle's lifecycle. By “logistics stage” is meant substantially from the point that the vehicle 10 is manufactured/completed at a factory to substantially the point at which the vehicle 10 is delivered to a dealer or is otherwise at a point-of-sale/ready to be used by an end user. The logistics mode is operable to perform the functions described herein during the logistics stage, and may be disabled/switched off by a dealer upon a vehicle arriving at a dealership (i.e. at the end of the logistics stage). Alternatively, the logistics mode may be switched off at a vehicle's pre-delivery inspection. Clearly, the engine of a vehicle will be switched off for most of the time during the logistics stage, and the vehicle battery 14 may be disconnected so as to preclude any possibility of battery drain.

The logistics stage typically lasts around one month, although this duration may be longer or shorter. This means that standard location tracking devices (with positional/GPS receivers) do not have sufficient battery life in order to track the location of the vehicle from the factory to the dealership. This also means that previously considered on-the-road telematics systems are unsuitable for such a purpose, as they are usually employed to constantly send large amounts of data off-vehicle during normal use by the end user, which uses significant amounts of power. Hence in current systems there are usually no signals being sent off-board the vehicle during the logistics stage. In contrast, in accordance with embodiments of the present invention, the TCU 16 manages the use of the vehicle battery 14 so that it remains operable (to send and receive messages) at key points throughout the logistics stage. This is achieved by utilising the one or more occasions in which the vehicle engine (or ignition) may be switched on during the logistics stage. For example, regulations may demand that the vehicle engine 12 needs to be switched on 30, 60 and/or 90 days after the vehicle 10 has been manufactured. Also, the vehicle 10 may need to be driven short distances (e.g. from manufacturing plant to transporter, from transporter to exit port loading area, from exit port loading area into container, from container to entry port loading area, from entry port loading area to transporter, from transporter to National Sales Company or distribution depot, from distribution depot to dealership etc.) during transportation to a dealership.

Normally, the vehicle battery 14 is disconnected by a power disconnect relay during the logistics stage; however, it is reconnected when the vehicle engine 12 needs to be switched on/the ignition is started (e.g. in the scenarios mentioned above). The processor 42 is arranged to determine whether the TCU 16 is operably connected to the vehicle battery 14 (which may occur when the ignition is switched on). In particular, the processor 42 is arranged to switch from the logistics quiet mode to the logistics activated mode when it is determined that the TCU 16 is operably connected to the vehicle battery 14. Specifically, upon it being determined that the TCU 16 is operably connected to the vehicle battery 14, the vehicle data inputs 30, 32 collect vehicle data from the ECUs 20 (which collect data from the vehicle sensors 24) and the location data antenna 18.

In practice, the TCU 16 may collect vehicle data from the point at which the vehicle engine 12 or ignition is switched on until substantially when the engine 12 is switched off or until a predetermined period after the engine 12 is switched off. Typically, the TCU 16 may continue to operate after the vehicle engine 12 has been switched off only for long enough to ensure it may establish a communications connection of some sort, such as to obtain a GPS or other location lock, establish a GPRS or other mobile network connection, and/or send the vehicle data off-board the vehicle 10. These actions may be performed so long as the period of time needed to carry them out does not exceed a pre-determined period, or the TCU battery 56 is not depleted below a certain level designed to protect the life of the battery. For example, in the event that the vehicle 10 is in a location where no mobile network coverage is available, it will not be able to send the vehicle data to off-board the vehicle 10, and hence it will automatically switch to the logistics quiet mode once that pre-determined time period or state of TCU battery charge has been reached. Note that the TCU battery 56 may comprise multiple batteries that are either rechargeable (e.g. being recharged by the vehicle 10 when the vehicle engine 12 is switched on), or non-rechargeable for use in the event that the TCU internal rechargeable battery 56 is fully consumed.

In addition, the wireless transmitter 54 sends the vehicle data off-board the vehicle 10 for processing via wireless signals (as is discussed below), and also receives wireless signals including data to be communicated to the ECUs 20 (also as discussed below). Since the TCU 16 may operate in the logistics quiet mode either all or most of the time that the ignition is switched off, it does not drain the power of the vehicle battery 14 during the logistics stage, but is still able to collect and send data off-board the vehicle 10 during this period. In one embodiment, use of the TCU 16 may be prohibited unless the ignition is on, to ensure that no draining of the vehicle battery takes place. Such prohibition may be for the entire logistics stage, or for certain parts of it, for example for a period of a delivery journey where it is expected that no communications with the vehicle will be possible.

The TCU 16 may also include a TCU battery or system battery 56. The TCU battery 56 is operable when the vehicle battery 14 is not operably connected to the TCU 16. Specifically, the TCU battery 56 may be operable when the TCU 16 is operating in the logistics quiet mode, and causes the TCU 16 to activate (i.e. to switch to the logistics activated mode). This means that the system can for instance be switched to the logistics activated mode without use of the vehicle battery 14. Thus in turn, vehicle sensors 24 can be activated, and/or communications messages transmitted and/or received while still drawing no power from the vehicle battery 14.

The activation of the TCU 16 via the TCU battery 56 may be carried out periodically, for example, at predetermined time intervals to check whether the wireless receiver 50 has received any wireless messages. This may involve connecting to a network such as a Short Message Service (SMS) network upon waking up. If messages have been received then the TCU 16 operates in the logistics activated mode so as to process the received messages.

The number of such activations between ignition-on events may be limited, in order that the battery life of the TCU battery 56 may be preserved.

Note that the instructions from any received wireless messages may instruct the TCU 16 to carry out one or more of a number of tasks. For example, any of the activities or tasks described herein which are carried out by, prompted by, scheduled for or assigned to the TCU 16 may also be prompted for action by a received message. For example, the received message may instruct the TCU 16 to collect vehicle data immediately, or to collect a certain type of vehicle data. The instructions may require the TCU 16 to re-activate again after a given period of time. The instructions may require a task related to a diagnostic check, as described in more detail below, such as extinguishing a cabin light which has been left on, draining the battery 14.

The inclusion of the TCU battery 56 (in addition to the vehicle battery 14) means that the TCU 16 may be operable even when the vehicle engine 12 is not switched on, but without draining the vehicle battery 14. This is particularly advantageous in cases where extended periods of time pass without the vehicle engine 12 being switched on. Also, the TCU battery 56 may recharge when the vehicle engine 12 is switched on (i.e. when the vehicle battery 14 is operably connected to the TCU 16) so that it may remain charged for the duration of the logistics stage.

The vehicle battery 14 and the TCU battery 56 may be arranged to operate at times different to those described above. For example, the batteries 14, 56 may be configured to operate in relation to the status of the vehicle engine 12 (i.e. on or off) such that overall power consumption is minimised or below a predetermined threshold. For example, it may be that use of the TCU battery 56, even in the low power consumption modes described herein, is limited to consumption below the threshold. This may be to ensure that a minimum level of TCU battery is available. The level of tasks assigned to the logistics modes may also be managed in dependence on the level of remaining battery; for example, it may be that once power consumption reaches an interim threshold, certain logistics tasks may be postponed, in favour of maintaining a minimum logistics output, such as at least monitoring the location of the vehicle.

In another example employed in embodiments of the invention, use of the vehicle battery 14 may be allowed in conjunction with the use of the TCU battery 56 until a certain level of consumption of the vehicle battery, at which point only use of the TCU battery will be permitted.

The TCU 16 may further include a memory device 58 that is in communication with the processor 42. In particular, the memory device 58 may have instructions stored therein and the processor 42 is arranged to access the stored instructions in order that it may perform the functions described above.

In the described embodiment, the present system may be used to track the progress of a vehicle as it is transported from a factory to a dealership. For example, the TCU 16 or broader system connected to the TCU 16 via the wireless network may be configured to create Geo-fences to define ports of countries, depots, factories, and/or dealerships. Since the position data input 46 receives the geographical location of the vehicle 10 and the TCU 16 or broader system knows the Geo-fences, it may be determined when the vehicle 10 has, for example, arrived at a port in a particular country. Off-board the vehicle 10, a person or party may be notified automatically that the vehicle 10 has entered a particular Geo-fence in order that they may then take an action. Actions could include liaising with service engineers to verify the physical state of the vehicle 10 or triggering other processes such as invoicing where such invoicing may not be permitted until the vehicle 10 has arrived on foreign soil.

The TCU 16 may have internal buffers which would allow messages that are due to be sent to be stored temporarily in the case of a loss of wireless connection, or an inability to obtain a wireless connection during a particular engine on/off cycle. Once the TCU 16 can ‘attach’ the messages are sent. This would also allow messages to be received when the TCU 16 is operating in the logistics quiet mode, and stored until it switches to the logistics activated mode. The TCU 16 will acknowledge when a message is received.

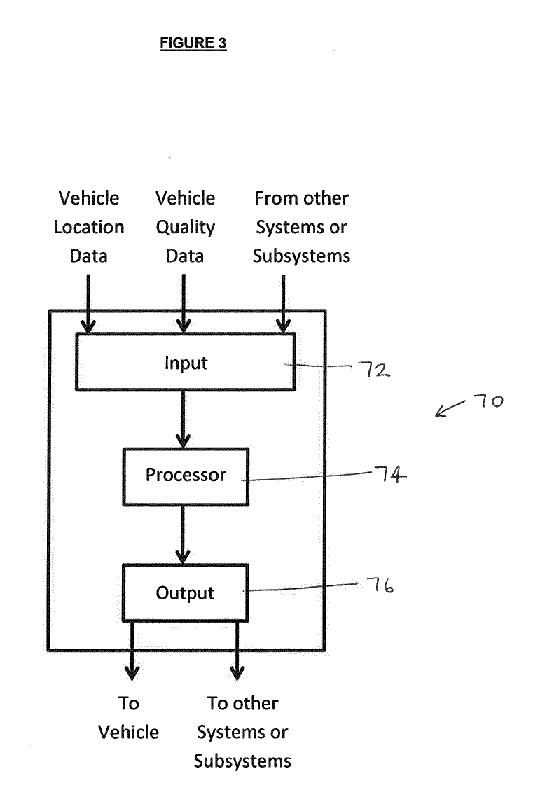

The present embodiment describes a case in which the wireless transmitter 54 sends the vehicle data off-board the vehicle 10 to a vehicle managing organisation. This organisation may be an Original Equipment Manufacturer (OEM) of the vehicle 10. In particular, and with reference to FIG. 3, the vehicle data is sent to a Logistics Management System (LMS) 70 of an OEM. The LMS 70 includes an LMS input 72, an LMS processor 74, and an LMS output 76. The input 72 may include location and quality data, which in turn may include measurements, alerts, and diagnostic data.

The LMS input 72 is arranged to receive wireless signals relating to the vehicle data described above. The wireless signals may be sent from the vehicle 10 via a wireless communication provider to the LMS 70. The wireless communication provider may be a mobile network operator. The LMS processor 74 of the LMS 70 analyses the received vehicle data so that the LMS output 76 may send signals to various other systems and subsystems either to trigger further processes (for example, as a consequence of the vehicle 10 reaching a certain stage in its journey as determined by a particular Geo-fence), or to provide them with up-to-date information relating to the vehicle 10.

For example, in the above-described case in which the TCU 16 uses Geo-fences to determine that the vehicle 10 has arrived in a particular country, this information may be processed by the LMS 70 and automatically communicated to, for example, an inventory management system of the OEM responsible for tracking and managing movement of a vehicle fleet and/or stock control. In current systems, such information would need to be entered manually into such an inventory management system. As mentioned previously, this would result in poor data quality, delay in propagating the updated data to adjacent processes, and poor data reliability.

Alternatively, or in addition, the vehicle data processed by the processor 74 may be sent to a finance system of the OEM. Again, the up-to-date positional data sent from the vehicle 10 may be used to inform such a finance system when, for example, a vehicle has reached its revenue recognition point (e.g. a third party dealership). It may be the case that the OEM cannot send an invoice to the third party for the vehicle until the vehicle has been delivered to the third party dealership, or until it has arrived on foreign soil where a National Sales Company may take delivery. In this case, rather than waiting and relying for the third party to report safe delivery of the vehicle, the OEM can use the received vehicle data to invoice the third party as soon as the vehicle is delivered. This eases cash flow problems introduced by poor communication by the third party (e.g. failure to manually update a system to report vehicle delivery).

As well as using the received positional data, the LMS 70 may process the received quality data to communicate the status of certain vehicle features to, for example, a logistics service provider (LSP). The LMS 70 may communicate to the LSP that, for example, any of the vehicle battery voltage level or state of charge, the tyre pressure level, the fuel level, or the oil level is below a desired threshold, or that the vehicle engine 12 has/has not had its mandatory 30, 60 and/or 90 day switch on. This could allow the LSP to take corrective action in a timely manner. The received positional data could also be sent to the LSP to allow the LSP to monitor the quality of service they are providing (e.g. are vehicles being delivered on time?), or to track the vehicle throughout a journey or the entire logistics stage.

The LMS 70 may not simply process received data to send information to the above-mentioned systems. Instead, the LMS 70 may transmit wireless messages to (and/or back, via the wireless communication provider, to) the vehicle 10 to, for example, rectify any problems reported in the received vehicle data. This may include scheduling a diagnostics check for one of the ECUs 20 that reported a problem in the quality data. The TCU 16 would then be responsible for instructing such a diagnostics check. The LMS 70 may also be able to instruct the TCU 16 to, for example, alter the tyre pressure automatically via a central tyre inflation system. Alternatively, the TCU processor 42 may be arranged to process the received quality data and so could, for example, schedule a diagnostics check for a particular ECU 20, obtain more detailed diagnostic information from that or related ECUs for sending off-board the vehicle for further analysis, or automatically send a control signal to alter tyre pressure without needing to send the vehicle data off-board the vehicle 10.

The processor 42 may also be operable to assess the performance of the vehicle engine 12 when the engine is switched on. During this period the processor 42 may be arranged to diagnose issues such as faulty engine components. Further, the processor 42 may be operable to send control signals to the vehicle engine such that, for example, it is placed into a safe mode in the event that faults are detected. The processor 42 may also be operable to transmit a communications message via the wireless transmitter 54 to off-board the vehicle 10 to, for example, book a service and potentially specify the activities to be undertaken or the parts to be inspected or replaced in the event that faults are detected. This could minimise delays in delivering a fully-functioning vehicle to an end user.

The TCU 16 may also be able to download software updates via the wireless communication antenna 26. Such software updates may be downloaded from the LMS 70 or elsewhere. This may enable the TCU 16 to collect different types of data, or to automatically process data received from other parts of the car to perform new functions for automation, diagnostics, or prognostics.

As mentioned above, the logistics mode of the TCU 16 may be switched off at the end of the logistics stage (e.g. when the vehicle reaches a dealership); however, it is possible that it may be switched back on at a future date. This could be of use in the case of, for example, a recall of the vehicle 10 by the manufacturer.

The TCU 16 may have modes other than the logistics mode described in the above for use at times other than the logistics stage. These may include, for example, an emergency mode for communicating a vehicle accident, a breakdown assistance mode, and/or a stolen vehicle tracking mode. Different modes of operation may be enabled at the same time. The TCU 16 is hence a flexible application platform that may be used to provide different services at different times or in different circumstances during the life-cycle of the vehicle 10 depending on the data received by the unit either from sensors in the vehicle or from off-board wireless communication.

The wireless communication of the vehicle data in the above could be sent to a central repository in the cloud that may be accessed by different suppliers, which advantageously means that consistent information could be readily available to various organisations.

1. A telematics control system for use in a vehicle and operable during a logistics stage of the vehicle, the system configured to determine whether to transmit vehicle data to off-board the vehicle, the vehicle including a vehicle battery and one or more vehicle sensors, the system comprising:
an input arranged to receive vehicle data from at least one of the one or more vehicle sensors;
a processor arranged to determine whether the vehicle battery is operably connected to the system; and
an output arranged to transmit a wireless communications message indicative of the received vehicle data to off-board the vehicle;
wherein the system includes a logistics activated mode in which it is operable to transmit communications messages and a logistics quiet mode in which it draws no power from the vehicle battery,
and wherein the processor is operable to switch from the logistics quiet mode to the logistics activated mode when it determines that the vehicle battery is operably connected to the system, and in the logistics activated mode to send the communications message from the output, so as to transmit vehicle data to off-board the vehicle.

2. The system according to claim 1, further comprising:
a memory device in communication with the processor and having instructions stored therein;
wherein the processor is arranged to access the memory device and execute the instructions stored therein such that the processor is operable to determine whether the vehicle battery is operably connected to the system.

3. The system according to claim 1, wherein, when in the logistics activated mode, the system is operable to activate at least one of the one or more vehicle sensors.

4. The system according to claim 1, wherein:
the vehicle data includes location data relating to a current location of the vehicle;
the one or more vehicle sensors includes a location data antenna configured to receive the location data; and
the input includes a position data input arranged to receive the location data from the location data antenna, optionally the location data antenna comprises a Global Positioning System (GPS) or other positioning system antenna and the position data input includes a GPS or other positioning data receiver.

5. (canceled)

6. The system according to claim 1, wherein:
the vehicle data comprises quality data relating to one or more vehicle features;
the one or more vehicle sensors comprises one or more quality data sensors for measuring the quality data; and
the input includes a quality data input arranged to receive the quality data from the quality data sensors.

7. The system according to claim 6, the vehicle including one or more electronic control units, and the quality data input being arranged to receive the quality data from the quality data sensors via the electronic control units, optionally wherein the electronic control units process the quality data received from the quality data sensors before the quality data is received by the quality data input.

8-9. (canceled)

10. The system according to claim 6, wherein the quality data comprises at least one of data indicative of at least one of a vehicle battery voltage level or state of charge, an amount of fuel in the vehicle, an odometer value, an oil level, a brake fluid level, and a tire pressure of one or more tires of the vehicle.

11. The system according to claim 1, wherein the vehicle includes:
a wireless transmitting antenna; and
the output comprises a wireless transmitter arranged to transmit the communications message to off-board the vehicle via the wireless transmitting antenna, and/or
a vehicle engine; and
wherein the processor determines that the vehicle battery is operably connected to the system when the vehicle engine or ignition is switched on.

12. (canceled)

13. The system according to claim 1, wherein:
the vehicle includes a wireless receiving antenna arranged to receive a communications message from off-board the vehicle with instructions to be carried out by the processor;
the input comprises a wireless receiver arranged to receive the communications message from the wireless receiving antenna; and
the processor is arranged to process the instructions received by the wireless receiver.

14. (canceled)

15. The system according to claim 13, wherein the processed instructions include instructions for at least one of a plurality of electronic control units to perform at least one of a diagnostics check, a software update, a tire pressure adjustment, a vehicle engine performance assessment, and an instruction to place the vehicle engine into a safe mode.

16. The system according to claim 1, wherein the processor is operable to assess the performance of the vehicle engine and/or to perform a diagnostics check, optionally the processor being operable to send control signals to rectify a detected problem with the vehicle engine.

17. (canceled)

18. The system according to claim 1, further comprising a system battery, wherein the system battery is arranged to power the system when the vehicle battery is not operably connected to the system, optionally wherein the system is arranged to draw no power from the system battery when the vehicle battery is operably connected to the system.

19. (canceled)

20. The system according to claim 18, wherein the system battery is arranged to recharge when the vehicle battery is operably connected to the system.

21. The system according to claim 18, wherein when the system is operating in the logistics quiet mode the system is configured to check periodically whether any wireless messages have been received, optionally wherein when it is determined that one or more wireless messages has been received, the processor is operable to switch from the logistics quiet mode to the logistics activated mode.

22-23. (canceled)

24. The system according to claim 18, wherein the system is arranged to draw power from the vehicle battery and/or the system battery such that power consumption is below a predetermined level, optionally wherein the system is arranged to remain operable while utilizing the vehicle battery and/or the system battery in order to substantially minimize the power consumption.

25. (canceled)

26. The system according to claim 1, wherein the system is arranged to operate in the logistics activated mode for a predetermined period after it is determined that the vehicle battery is not operably connected to the system, and/or after it is determined that the vehicle battery is not operably connected to the system, for a period sufficient to ensure establishment of a communications connection.

27. (canceled)

28. A telematics control method for use in a vehicle and operable during a logistics stage of the vehicle for determining whether to transmit vehicle data to off-board the vehicle, the vehicle including a vehicle battery, one or more vehicle sensors and a telematics control system, wherein the system includes a logistics activated mode in which it is operable to transmit communications messages and a logistics quiet mode in which it draws no power from the vehicle battery, the method comprising:
receiving vehicle data from at least one of the one or more vehicle sensors;
determining whether the vehicle battery is operably connected to the system;
transmitting a wireless communications message indicative of the received vehicle data to off-board the vehicle; and
switching the system from the logistics quiet mode to the logistics activated mode when it is determined that the vehicle battery is operably connected to the system, and in the logistics activated mode to send the communications message, so as to transmit vehicle data to off-board the vehicle.

29. A telematics control method for use with a vehicle and operable during a logistics stage of the vehicle, the vehicle including a vehicle battery, one or more vehicle sensors and a telematics control system, wherein the system includes a logistics activated mode in which it is operable to transmit communications messages and a logistics quiet mode in which it draws no power from the vehicle battery, the method comprising:
receiving vehicle data from at least one of the one or more vehicle sensors;
determining whether the vehicle battery is operably connected to the system;
transmitting a wireless communications message indicative of the received vehicle data to off-board the vehicle;
switching the system from the logistics quiet mode to the logistics activated mode when it is determined that the vehicle battery is operably connected to the system, and in the logistics activated mode to send the communications message, so as to transmit vehicle data to off-board the vehicle; and
transmitting the communications message to a logistics management system and/or to a logistics service provider.

30. A non-transitory, computer-readable storage medium storing instructions thereon that when executed by one or more processors causes the one or more processors to carry out the method of claim 28.

31. A vehicle comprising the system according to claim 1.

32-34. (canceled)
